(19) United States
(12) Patent Application Publication
(10) Pub. No.: US 2024/0157455 A1
(43) Pub. Date: May 16, 2024

(54) HORIZONTAL BAND SAW MACHINE

(71) Applicants: AMADA CO., LTD., Kanagawa (JP); AMADA MACHINERY CO., LTD., Kanagawa (JP)

(72) Inventors: Norihisa SAKAI, Kanagawa (JP); Susumu TADANO, Kanagawa (JP)

(73) Assignees: AMADA CO., LTD., Kanagawa (JP); AMADA MACHINERY CO., LTD., Kanagawa (JP)

(21) Appl. No.: 18/281,293

(22) PCT Filed: Mar. 10, 2022
(86) PCT No.: PCT/JP2022/010455

§ 371 Date: Sep. 9, 2023

(30) Foreign Application Priority Data
Mar. 15, 2021 (JP) 2021-041452

(51) Int. Cl. B23D 53/04; B23D 55/08

(52) U.S. Cl. CPC B23D 53/04; B23D 55/08

(57) ABSTRACT

A horizontal band saw machine includes a fixing vise jaw and a cutting head configured to cut a workpiece while descending along a guide post extending in a vertical direction. The cutting head includes a housing to which a driving wheel and a driven wheel are rotatably attached, and an endless band saw blade tightly stretched between the driving wheel and the driven wheel. When the workpiece a is cut with the band saw blade, a center of the driving wheel is located above a center of the driven wheel and the housing moves linearly up and down along the guide post. A fixing vise reference, which is a vertical plane on which the fixing vise jaw fixes the workpiece, shares a cutting end point at which the band saw blade ends cutting of the workpiece.

### TECHNICAL FIELD

The present invention relates to a horizontal band saw machine.

### BACKGROUND ART

In conventional horizontal band saw machines, cutting is performed with a band saw blade in a state of being tilted from a horizontal direction so that an upward inclination can be formed in a direction in which a width of a workpiece widens when viewed from a fixing vise jaw that fixes the workpiece. In this type of horizontal band saw machine, there is a necessity to deal with such a problem that a cutting end point at which the cutting of the workpiece ends changes in accordance with cutting conditions such as the width and a cross-sectional shape of the workpiece (see Patent Literature 1, for example).

### CITATION LIST

### Patent Literature

Patent Literature 1: Japanese Utility Model Laid-Open No. 61-035716

### SUMMARY

However, the conventional method is accompanied by complexity because it is necessary to detect or calculate the cutting end point when the workpiece is cut.

A horizontal band saw machine according to an aspect of the present invention includes a fixing vise jaw configured to fix a workpiece by holding the workpiece between the fixing vise jaw and a movable vise jaw, a guide post extending linearly in a vertical direction, and a cutting head configured to cut the workpiece while descending along the guide post, in which the cutting head includes a housing to which a driving wheel and a driven wheel are rotatably attached, and an endless band saw blade tightly stretched between the driving wheel and the driven wheel. When the workpiece is cut with the band saw blade between the driving wheel and the driven wheel, a center of the driving wheel is located above a center of the driven wheel, and the housing moves linearly up and down along the guide post while maintaining a positional relationship between the driving wheel and the driven wheel. A fixing vise reference, which is a vertical plane on which the fixing vise jaw fixes the workpiece, shares a cutting end point at which the band saw blade ends cutting of the workpiece.

According to the horizontal band saw machine related to the one aspect of the present invention, since the fixing vise reference shares the cutting end point, the cutting end point can be uniquely defined regardless of cutting conditions. Therefore, it is not necessary to detect or calculate the cutting end point when the workpiece is cut.

According to the one aspect of the present invention, it is possible to eliminate complexity when the workpiece is cut.

### BRIEF DESCRIPTION OF DRAWINGS

FIG. 1 is a front view showing a horizontal band saw machine according to the present embodiment.

FIG. 2 is a top view showing the horizontal band saw machine according to the present embodiment.

FIG. 3 is a diagram showing a relationship between a travel line of the band saw blade and a turning angle.

FIG. 4 is a diagram showing the relationship between the travel line of the band saw blade and the turning angle.

FIG. 5 is an explanatory diagram showing the horizontal band saw machine according to the present embodiment.

### DESCRIPTION OF EMBODIMENT

A horizontal band saw machine according to the present embodiment will be described below with reference to the drawings. In the following description, the left-right direction, the front-rear direction, and the up-down direction are used to define directions, but these directions are used only for convenience of the description. The left-right direction and the front-rear direction correspond to the horizontal direction, and the up-down direction corresponds to the vertical direction.

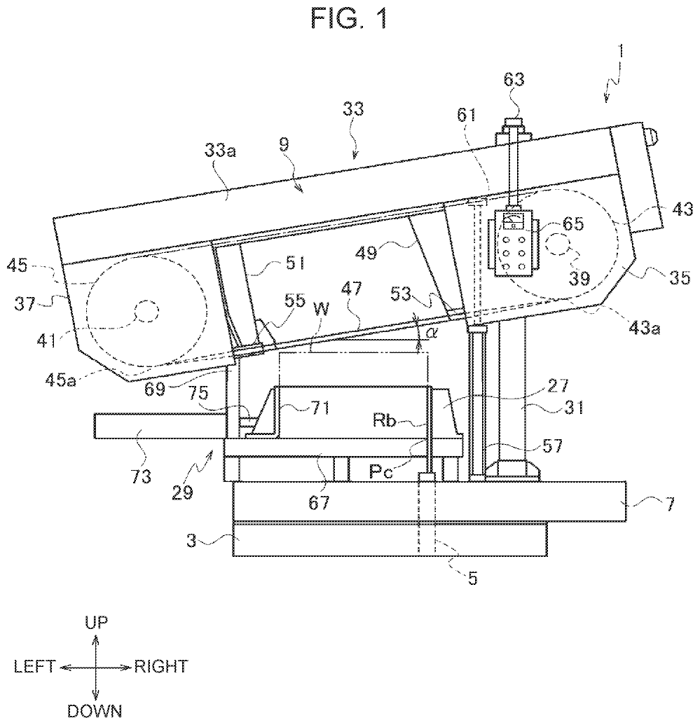

FIG. 1 is a front view showing a horizontal band saw machine according to the present embodiment. As shown in FIG. 1, a horizontal band saw machine 1 includes a fixing vise jaw 27 configured to fix a workpiece W by holding the workpiece W between the fixing vise jaw 27 and a movable vise jaw 71, a guide post 31 that extends linearly in the vertical direction, and a cutting head 9 configured to cut the workpiece W while descending along the guide post 31. The cutting head 9 includes a housing 33 to which a driving wheel 43 and a driven wheel 45 are rotatably attached, and an endless band saw blade 47 that is tightly stretched between the driving wheel 43 and the driven wheel 45. A center of the driving wheel 43 is located above a center of the driven wheel 45, and the housing 33 moves linearly up and down along the guide post 31 while maintaining a positional relationship between the driving wheel 43 and the driven wheel 45. A fixing vise reference Rb, which is a vertical plane on which the fixing vise jaw 27 fixes the workpiece W, shares a cutting end point Pc at which the band saw blade 47 ends cutting of the workpiece W.

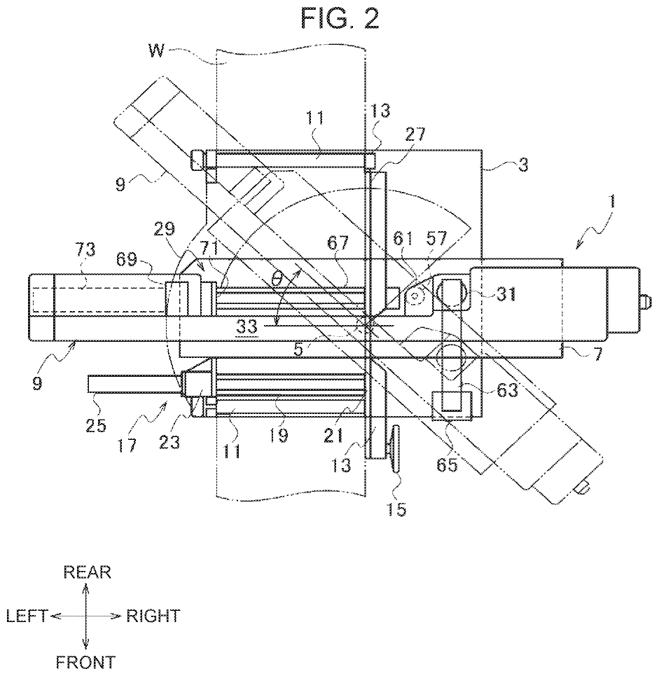

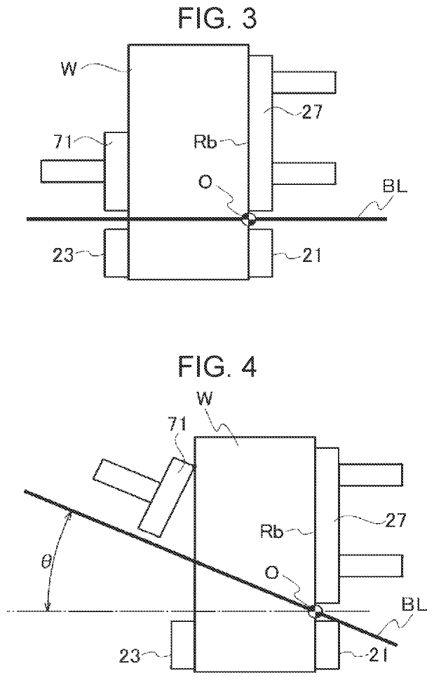

FIG. 2 is a top view showing the horizontal band saw machine according to the present embodiment. FIGS. 3 and 4 are diagrams showing a relationship between a travel line of the band saw blade and a turning angle. Next, the configuration of the horizontal band saw machine 1 according to the present embodiment will be described in detail with reference to FIGS. 1 to 4. The horizontal band saw machine 1 is a machining device that cuts the workpiece W with the band saw blade 47. The workpiece W to be processed is a long workpiece that is longitudinal in the front-rear direction. For example, the workpiece W is a shape steel such as an H-shaped steel (or an I beam, an H beam, a W beam, a universal beam, a Rolled Steel Joist (RSJ), a beam with an I or H-shaped cross section, which is also referred to as a double-T).

The horizontal band saw machine 1 is mainly composed of a base frame 3, the cutting head 9, and an NC (Numerical Control) device 65. The base frame 3 includes a pin 5, a machine base 7, support rollers 11, a front vise device 17, the fixing vise jaw 27, a turning vise device 29, the guide post 31, and the like.

The pin 5 is provided on the base frame 3 so as to stand in the vertical direction. The pin 5 penetrates the machine base 7 mounted on the base frame 3, and an upper end of the pin 5 slightly protrudes upward from an upper surface of the machine base 7.

The machine base 7 is mounted on the base frame 3 and rotates in the horizontal direction with the pin 5 as the center. The machine base 7 can be turned by operating an unillustrated turning actuation device. By turning the machine base 7, the cutting head 9 is also turned in synchronization so as to be able to cut the workpiece W at a turning angle θ, that is, the angle θ inclined from a direction perpendicular to a longitudinal direction of the workpiece W (a width direction of the workpiece W).

The support rollers 11 support and convey the workpiece W. The support rollers 11 are provided on both front and rear sides of the base frame 3. Each of the support rollers 11 is rotatably supported by a roller stand 13. The workpiece W is supported by the front and rear support rollers 11, which defines a lower end of the workpiece W on a horizontal plane including a top portion of each of the support rollers 11 (a workpiece support reference Rw, which will be described later).

The roller stand 13 on the front side is provided with, for example, a handle 15 for conveying the workpiece. The handle 15 is connected to the front and rear support rollers 11 via a chain or the like. By rotating the handle 15, the front and rear support rollers 11 are rotated, thereby the workpiece W can be conveyed from the rear side to the front side.

The front vise device 17 fixes the workpiece W in front of a travel line BL of the band saw blade 47. The front vice device 17 is arranged in front of the pin 5 and behind the support roller 11 on the front side. The front vise device 17 includes a front vise bed 19, a front fixing vise jaw 21, and a front movable vise jaw 23.

The front fixing vice jaw 21 is fixed to one end side of the front vice bed 19 provided in the left-right direction. A rear end side of the front fixing vise jaw 21 is fixed to an upper end of the pin 5 projecting upward from the machine base 7. The front movable vice jaw 23 is attached on the front vice bed 19. The front movable vice jaw 23 is configured to be movable forward and backward to approach the front fixing vice jaw 21 and to be separated from the front fixing vice jaw 21. The forward and backward movement of the front movable vice jaw 23 is performed by a front vice cylinder 25 provided to a side portion of the front vice bed 19. The front fixing vise jaw 21 and the front movable vise jaw 23 fix the workpiece W by holding the workpiece W from both sides.

The fixing vise jaw 27 fixes the workpiece W behind the travel line BL of the band saw blade 47. The fixing vise jaw 27 is supported between the pin 5 and the roller stand 13 on the rear side. A portion at which the fixing vice jaw 27 and the front fixing vice jaw 21 are connected to the pin 5 is formed in a slit shape into which the band saw blade 47 can enter so as to avoid interference with the band saw blade 47.

The turning vise device 29 fixes the workpiece W in cooperation with the fixing vise jaw 27. The turning vise device 29 is provided on the machine base 7 and turns, with the pin 5 as the center, together with the machine base 7. The turning vise device 29 includes a vise bed 67 and the movable vise jaw 71.

One end side of an upper surface of the vise bed 67 is located on a lower surface of the fixing vise jaw 27. On the other end side of the upper surface of the vise bed 67, a sub-guide post 69 is provided at a position away from the guide post 31. The sub-guide post 69 extends linearly in the vertical direction. The sub-guide post 69 guides a linear vertical movement of the cutting head 9 together with the guide post 31.

On the other end side of the upper surface of the vice bed 67, the movable vice jaw 71 is provided. The movable vice jaw 71 is configured to be movable forward and backward to approach the fixing vice jaw 27 and to be separated from the fixing vice jaw 27. The forward and backward movement of the movable vice jaw 71 is performed by a vice cylinder 73 mounted to the sub-guide post 69. The fixing vise jaw 27 and the movable vise jaw 71 fix the workpiece W by holding the workpiece W from both sides.

The guide post 31 is provided on the machine base 7 and extends linearly in the vertical direction. The guide post 31 guides the linear vertical movement of the cutting head 9.

The cutting head 9 is arranged above the machine base 7. The workpiece W supported by the support rollers 11 exists between the cutting head 9 and the machine base 7. The cutting head 9 cuts the workpiece W while descending in the vertical direction. The cutting head 9 includes the housing 33 and the band saw blade 47.

The housing 33 is attached to the guide post 31 and the sub-guide post 69, and is configured to be movable in a direction in which the guide post 31 and the sub-guide post 69 extend. A hydraulic cylinder 57 for ascending and descending the housing 33 is provided at a position close to the guide post 31. A tip end of a piston rod of the hydraulic cylinder 57 for ascending and descending is connected to a bracket portion 61 of the housing 33. When the hydraulic cylinder 57 is operated, the housing 33 linearly moves up and down along the guide post 31 and the sub-guide post 69.

The housing 33 is composed of a beam member 33a extending in the left-right direction, and housing body parts 35 and 37 respectively provided at opposite ends of the beam member 33a. The driving wheel 43 is provided to the housing body part 35 on one end, and the driven wheel 45 is provided to the housing body part 37 on the other end. The driving wheel 43 and the driven wheel 45 are separated from each other and face each other with the workpiece W therebetween. The driving wheel 43 is located closer to a side of the fixing vice jaw 27 with respect to the workpiece W, and the driven wheel 45 is located closer to a side of the movable vice jaw 71 with respect to the workpiece W.

A driving shaft 39 rotatably attached to the housing body part 35 is inserted at a center of the driving wheel 43. The driving shaft 39 is rotated by a power transmitted from a drive mechanism such as a motor. The driving wheel 43 rotates as the driving shaft 39 rotates. A driven shaft 41 rotatably attached to the housing main body part 37 is inserted at a center of the driven wheel 45.

Between the driving wheel 43 and the driven wheel 45, the endless band saw blade 47 for sawing to cut the workpiece W is tightly stretched. It should be noted that some band saw machines include two or more wheels to be driven, but the driven wheel 45 shown in the present embodiment refers to a driven wheel for forming a region between the wheel 43 and the driven wheel in which the endless band saw blade 47 for sawing to cut the workpiece W is tightly stretched. Of the band saw blade 47, the region between the driving wheel 43 and the driven wheel, that is, a cutting region in which the workpiece W is cut, is vertically twisted and raised by saw blade guides 53 and 55. The saw blade guide 53 on one side is provided at a lower end of a fixed guide arm 49 fixed to the beam member 33a. The saw blade guide 55 on the other side is provided at a lower end of a movable guide arm 51 movably attached along the beam member 33a.

As one of the features of the present embodiment, an inclination is set to the beam member 33a of the housing 33, which is inclined downward in a direction in which a width of the workpiece W widens viewed from the fixing vise jaw 27, that is, in a direction in which the movable vise jaw 71 is separated from the fixing vise jaw 27. In correspondence to an inclination angle of the beam member 33a, the driving shaft 39, which is the center of the driving wheel 43, is located above the driven shaft 41, which is the center of the driven wheel 45. A wheel diameter of the driving wheel 43 and a wheel diameter of the driven wheel 45 correspond to each other, and a lower end 43a of the driving wheel 43 is located above a lower end 45a of the driven wheel 45. Therefore, the band saw blade 47 is provided with an inclination angle α that forms a downward inclination in the direction in which the width of the workpiece W widens. The housing 33 moves linearly up and down along the guide post 31 while maintaining the inclination angle α, that is, a positional relationship between the driving wheel 43 and the driven wheel 45.

As the machine base 7 turns with the pin 5 as a turning center, the movable vise jaw 71 and the cutting head 9 also turn with the pin 5 as the turning center. As shown in FIGS. 3 and 4, the vertical plane on which the workpiece W is fixed in the front fixing vise jaw 21 and the fixing vise jaw 27 is defined as the fixing vise reference Rb, which is a reference plane. In this case, a turning center O of the movable vise jaw 71 and the cutting head 9 coincides with an intersection between a vertical plane passing through the travel line BL of the band saw blade 47 and the fixing vise reference Rb.

The NC device 65 is provided above the guide post 31 via an arm member 63. The NC device 65 is a control device that controls the horizontal band saw machine 1. Detection signals are input to the NC device 65 from various sensors that detect an amount of descent of the cutting head 9 and the like. The NC device 65 controls rotation of the band saw blade 47 and ascent and descent of the cutting head 9 based on these detection signals and a processing program.

In relation to the present embodiment, the NC device 65 determines whether or not the band saw blade 47 has descended to the cutting end point Pc, which will be described later, based on the detection signal of the sensor that detects the amount of descent of the cutting head 9. When the NC device 65 determines that the band saw blade 47 has descended to the cutting end point Pc, the NC device 65 performs an operation to raise the housing 33 to a predefined home position.

In the horizontal band saw machine 1 having such a configuration, the workpiece W is positioned at an appropriate position by operating the handle 15 to convey the workpiece W. When the workpiece W is positioned, the workpiece W is fixed by the front vise device 17, the fixing vise jaw 27, and the turning vise device 29. Under the control of the NC device 65, the driving wheel 43 is rotated to travel the band saw blade 47 and the cutting head 9 is lowered along the guide post 31 so that the workpiece W is cut.

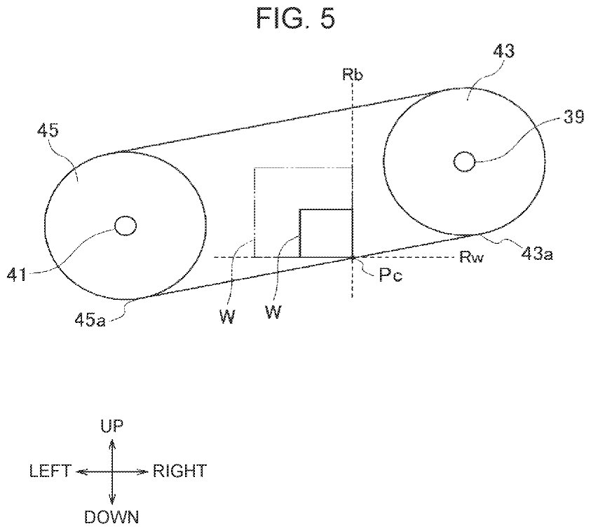

FIG. 5 is an explanatory diagram showing a relationship between the width of the workpiece and the cutting end point. FIG. 5 shows two types of the workpieces W having different widths. When the cutting head 9 cuts the workpiece W while descending along the guide post 31, a cutting length differs depending on the width of the workpiece W.

In the horizontal band saw machine 1 according to the present embodiment, the center of the driving wheel 43 is located above the center of the driven wheel 45, and the inclination angle α, which forms the downward inclination in the direction in which the width of the workpiece W widens, is also provided to the band saw blade 47. The cutting of the workpiece W by the band saw blade 47 progresses from the side of the movable vise jaw 71 toward the side of the fixing vise jaw 27, and ends at the fixing vise reference Rb. More specifically, the cutting of the workpiece W by the band saw blade 47 ends at an intersection between the workpiece support reference Rw, which is the horizontal plane defining the lower end of the workpiece W, and the fixing vice reference Rb. The relationship that the cutting of the workpiece W ends at the intersection between the workpiece support reference Rw and the fixing vice reference Rb is invariable regardless of the width of the workpiece W. Therefore, regardless of the width of the workpiece W, the intersection between the workpiece support reference Rw and the fixing vise reference Rb can be defined as the cutting end point Pc at which the band saw blade 47 ends the cutting of the workpiece W.

In this manner, in the horizontal band saw machine 1 according to the present embodiment, since the cutting end point Pc can be assigned to the fixing vice reference Rb, the fixing vice reference Rb shares the cutting end point Pc. In other words, the fixing vise reference Rb includes the cutting end point Pc in its plane and also serves as the cutting end point Pc. Because of this, the cutting end point Pc is invariable regardless of the width of the workpiece W (an example of the processing conditions), so that the cutting end point Pc can be uniquely defined. As a result, since it is not necessary to detect or calculate the cutting end point Pc when the workpiece W is cut, complexity when the workpiece W is cut can be eliminated.

It should be noted that in FIG. 5, the difference in the cutting length due to the difference in the width of the workpiece W has been explained. However, even when the same workpiece W is cut, such a difference in the cutting length is generated due to a difference in the turning angle θ. In this regard, according to the horizontal band saw machine 1 related to the present embodiment, the cutting of the workpiece W by the band saw blade 47 ends at the intersection between the workpiece support reference Rw and the fixing vise reference Rb regardless of the turning angle θ. Therefore, the intersection between the workpiece support reference Rw and the fixing vise reference Rb can be defined as the cutting end point Pc regardless of the turning angle θ. Since the cutting end point Pc can be assigned to the fixing vise reference Rb, the fixing vise reference Rb shares the cutting end point Pc. In other words, regardless of the width of the workpiece W and even when the cutting head 9 is turned with the pin 5 as the center of the rotation, the intersection between the workpiece support reference Rw and the fixing vise reference Rb can be uniquely defined as the cutting end point Pc at which the band saw blade 47 ends the cutting of the workpiece W.

Further, according to the horizontal band saw machine 1 related to the present embodiment, it is possible to achieve a secondary effect described below.

For example, when a square column is cut from a top surface toward a bottom surface, a situation may occur in which chips accumulated on a top of the bottom surface are trapped in the band saw blade when the bottom surface is cut. However, in the present embodiment, since the center of the driving wheel 43 is located above the center of the driven wheel 45, the band saw blade 47 cuts the workpiece W in such a manner as to pull the workpiece W for cutting. As a result, it is possible to prevent the chips from being trapped. Therefore, it is possible to take measures against chipping of the band saw blade 47 and to improve processing accuracy of a cut surface.

Further, since the band saw blade 47 cuts the workpiece W in such a manner as to pull the workpiece W for cutting, it is possible to prevent burrs that are generated on the cut surface or to suppress the size of the burrs that are generated.

Further, since the cutting end point Pc is located on a side of the fixing vise reference Rb, it is not necessary to consider a width error due to an individual difference of the workpiece W. As a result, an air-cutting amount can be reduced to zero or be significantly reduced, so that work efficiency can be improved.

In addition, the horizontal band saw machine 1 according to the present embodiment may be a multitasking processing machine provided with a drill head, which is capable of drilling the workpiece W, on a side upstream of the cutting head 9 in a direction in which the workpiece W is conveyed. As described above, since the center of the driving wheel 43 is located above the center of the driven wheel 45, the band saw blade 47 cuts the workpiece W in such a manner as to pull the workpiece W for cutting. Therefore, it is possible to prevent a situation in which the chips accumulated on the workpiece W in the drilling of the previous process are trapped in the band saw blade 47. As a result, it is possible to take the measure against the chipping of the band saw blade 47 and to improve the processing accuracy of the cut surface.

It should be noted that in the embodiment described above, the inclination is set to the beam member 33a of the housing 33. However, if the center of the driving wheel 43 is located above the center of the driven wheel 45, the beam member 33a may be horizontal.

Further, in the embodiment described above, the wheel diameter of the driving wheel 43 and the wheel diameter of the driven wheel 45 correspond to each other. However, if the lower end 43a of the driving wheel 43 is located above the lower end 45a of the driven wheel 45, the wheel diameters do not have to correspond to each other.

Further, in the embodiment described above, the shape steel is given as the example of the workpiece, but the workpiece W is not limited to this. The horizontal band saw machine 1 according to the present embodiment can be widely applied to a workpiece W having a cross-sectional shape such that an end of the workpiece W exists at the intersection between the workpiece support reference Rw and the fixing vice reference Rb.

Further, in the embodiment described above, the inclination angle α, which forms the downward inclination in the direction in which the width of the workpiece W widens, is set to the band saw blade 47. However, the setting of the inclination angle α does not need to cover the entire band saw blade 47, but only needs to cover at least the cutting region.

As described above, the embodiments of the present invention have been described, but the statements and drawings forming a part of the present disclosure should not be understood to limit the present invention. From the present disclosure, various alternative embodiments, implementational examples and operational techniques will become apparent to those skilled in the art.

The disclosure of the present application relates to the subject matter described in Japanese Patent Application No. 2021-041452 filed on Mar. 15, 2021, the entire disclosure of which is incorporated herein by reference.

1. A horizontal band saw machine, comprising:
a fixing vise jaw configured to fix a workpiece by holding the workpiece between the fixing vise jaw and a movable vise jaw;
a guide post extending linearly in a vertical direction; and
a cutting head configured to cut the workpiece while descending along the guide post, wherein
the cutting head includes
a housing to which a driving wheel and a driven wheel are rotatably attached, and
an endless band saw blade tightly stretched between the driving wheel and the driven wheel,
a center of the driving wheel is located above a center of the driven wheel,
when the workpiece is cut with the band saw blade between the driving wheel and the driven wheel,
the housing moves linearly up and down along the guide post while maintaining a positional relationship between the driving wheel and the driven wheel, and
a fixing vise reference, which is a vertical plane on which the fixing vise jaw fixes the workpiece, shares a cutting end point at which the band saw blade ends cutting of the workpiece.

2. The horizontal band saw machine according to claim 1, further comprising a machine base configured to be able to turn in a horizontal direction and to which the guide post is provided, wherein
a turning center of the cutting head exists at an intersection between the fixing vise reference and a travel line of the band saw blade.

3. The horizontal band saw machine according to claim 1, wherein the cutting end point exists at an intersection between a workpiece support reference, which is a horizontal plane defining a lower end of the workpiece and the fixing vise reference.

4. The horizontal band saw machine according to claim 1, wherein a lower end of the driving wheel is located above a lower end of the driven wheel.

5. The horizontal band saw machine according to claim 1, wherein
the driving wheel is located closer to a side of the fixing vice jaw with respect to the workpiece; and
the driven wheel is located closer to a side of the movable vice jaw with respect to the workpiece.
